(19) United States
(12) Patent Application Publication
(10) Pub. No.: US 2015/0066578 A1
(43) Pub. Date: Mar. 5, 2015

(54) SYSTEM AND METHOD FOR ASSESSING ORGANIZATIONAL HEALTH-RELATED RISK AND READINESS FOR WELLNESS AND DISEASE MANAGEMENT PROGRAMMING

(71) Applicants: MICHAEL MANOCCHIA, CUMBERLAND, RI (US); ROBERT H. ROSS, WATERFORD, ME (US)

(72) Inventors: MICHAEL MANOCCHIA, CUMBERLAND, RI (US); ROBERT H. ROSS, WATERFORD, ME (US)

(21) Appl. No.: 14/469,203

(22) Filed: Aug. 26, 2014

Related U.S. Application Data
(63) Continuation of application No. 12/241,680, filed on Sep. 30, 2008, now abandoned.

(51) Int. Cl. G06Q 10/06; G06F 19/00

(52) U.S. Cl. CPC G06Q 10/0635; G06Q 10/06393; G06F 19/363
USPC 705/7.28

(57) ABSTRACT

A computer-implemented system and method are provided as an organizational risk and readiness assessment tool (ORA) for assessing organizational health-related risks and readiness for wellness and disease management programming. Survey data is collected for an organization, such as environmental survey data, leadership survey data and health culture survey data. The survey data may include binary survey data and scalar survey data. A scoring engine generates one or more readiness scores for the organization by applying at least one scoring algorithm to the survey data to generate one or more risk and/or readiness scores for the organization. The risk and/or readiness scores may relate to the environment, leadership perceptions, and health culture of the organization. Overall risk and readiness scores may also be generated. Report data generated for the organization enables graphic display of one or more of the organization's risk and readiness scores generated by the scoring engine, for example, including a color-coded display of the organization's environmental, leadership, health culture and overall readiness scores.

### FIELD OF THE INVENTION

The present invention generally relates to a system and method for assessing organizational health and wellness related risks and/or readiness for wellness and disease management programming in which healthy environments at work, company leadership support of health programming and worker perceptions of health culture are assessed to determine the extent to which an organization is prepared to initiate, implement, and/or improve their wellness and disease management programs for their employees or member populations. The system and method are implemented as a computer-implemented organizational risk assessment tool that utilize a combination of surveys, algorithms and reports to assess organizational health and wellness related risks and readiness for wellness and disease management programming applied to working or member populations.

### BACKGROUND OF THE INVENTION

Two-thirds of U.S. adults, including working adults, are now overweight (BMI≧25) or obese (BMI≧30) As a result, they are at elevated risk for diseases and conditions, including hypertension, dyslipidemia, type 2 diabetes, coronary heart disease, and osteoarthritis. See Surgeon General Report (2001): www.surgeongeneral.gov/topics/obesity/calltoaction/toc.htm.

In the workplace, weight-related health conditions such as those mentioned above are known to increase absenteeism, decrease productivity, and increase health and disability insurance premiums. The association between overweight and obesity, health care costs, and absenteeism is progressive: above the low point (BMI 25-27), additional health risks, short-term disability, absence due to illness, medical claims, and health care costs steadily rise. See Burton, Wayne N. MD; Chen, Chin-Yu PhD; Schultz, Alyssa B. MS; Edington, Dee W. PhD; “The Economic Costs Associated With Body Mass Index in a Workplace,” Journal of Occupational & Environmental Medicine. 40(9):786-792, September 1998. Overweight and obesity cost U.S. businesses approximately $17 billion in 2006 (CPI-adjusted ˜$12.7 billion in 1994). See Thompson, David; Edelsberg, John; Kinsey, Karen L; Oster, Gerry; “Estimated Economic Costs of Obesity to U.S. Business,” American Journal of Health Promotion, Volume 13, Issue 2, pp. 120-127 (November 1998).

Currently, there is a need for a system and method that provide a standardized, reliable and validated assessment of the health-related environments at work to assist organizations in assessing their options for initiating, implementing, and/or improving their wellness and disease management programs for their employees or member populations.

### SUMMARY OF THE INVENTION

The system and method according to the present invention provide a standardized assessment of the health-related environments at work by assessing healthy environmental and physical domains of the workplace, leadership support for a healthy work environment, and employees' perceptions of health culture at their worksite.

The system and method according to the present invention may be implemented as a computer-implemented organizational risk assessment tool (ORA) that fulfills these requirements to provide a standardized assessment or scorecard of various aspects of the health, wellness and disease management assessment landscape.

According to one implementation of the present invention, the system and method serve to structure and guide a worksite's efforts to change each of a plurality of work-related domains so as to make the worksite more health-promoting thus less obsogenic. The system and method may impact the organizational approach to wellness at work and create a healthier culture in the workplace.

A computer-implemented system for assessing organizational health and wellness related risks and readiness for wellness and disease management programming may include data storage for storing survey data collected for an organization to be assessed, wherein the survey data for the organization includes environmental survey data, leadership survey data and health culture survey data; and a scoring engine for generating one or more risk and/or readiness scores for the organization based upon the stored survey data, wherein the scoring engine (a) applies a first scoring algorithm to the environmental survey data to generate at least one environmental risk and/or readiness score, (b) applies a scoring algorithm to the leadership survey data to generate at least one leadership risk and/or readiness score, and (c) applies a third algorithm to the health culture survey data to generate at least one health culture risk and/or readiness score. The scoring engine may store the risk and/or readiness scores generated for the organization and further generate report data for the organization to enable graphic display of one or more of the organization's risk and/or readiness scores generated by the scoring engine. The stored survey data may include binary survey data and scalar survey data.

A computer-implemented method for assessing organizational risk and/or readiness for wellness and disease management programming may include: storing survey data collected for an organization to be assessed, wherein the survey data for the organization includes environmental survey data, leadership survey data and health culture survey data; generating one or more risk and/or readiness scores for the organization based upon the stored survey data by (a) applying a first scoring algorithm to the environmental survey data to generate at least one environmental risk and/or readiness score, (b) applying a scoring algorithm to the leadership survey data to generate at least one leadership risk and/or readiness score, and (c) applying a third algorithm to the health culture survey data to generate at least one health culture risk and/or readiness score; storing the risk and/or readiness scores generated for the organization; and generating report data for the organization to enable graphic display of one or more of the organization's risk and/or readiness scores.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 depicts a system for assessing organizational risk and/or readiness for wellness and disease management programming in accordance with the present invention.

FIG. 2 depicts a functional block diagram of a method for assessing organizational risk and/or readiness for wellness and disease management programming as implemented by system 100 in FIG. 1.

FIG. 3 (1 of 4) provides an illustrative example of a score card generated by the system of FIG. 1; FIG. 3 (2 of 4) provides an illustrative example of strategic recommendations; FIG. 3 (3 of 4) provides an illustrative example of total, domain, and sub-domain name scores; FIG. 3 (4 of 4) is a continuation of the scores.

FIG. 4 (1 of 3) provides an illustrative example of a presentation generated by the system of FIG. 1; FIG. 4 (2 of 3) provides an illustrative example of a worksite score card and recommendations; FIG. 4 (3 of 3) provides an illustrative example of follow-up.

### DETAILED DESCRIPTION

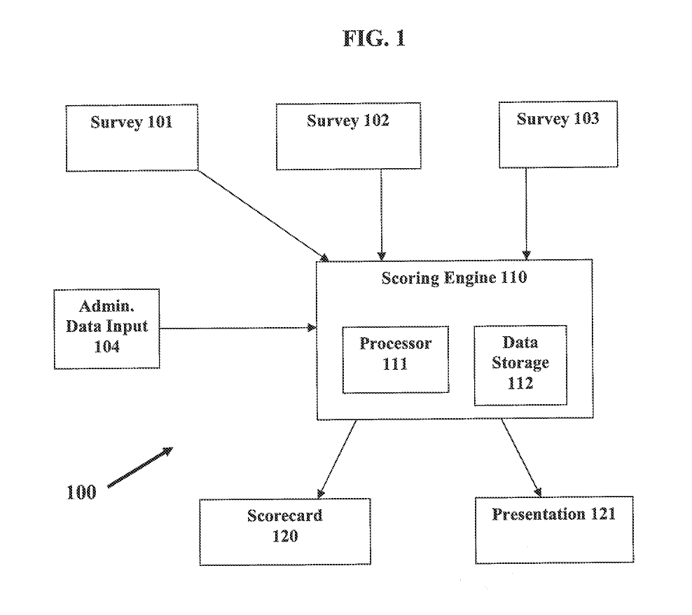

With reference to the accompanying drawings, FIG. 1 depicts a system 100 for assessing organizational risk and/or readiness for wellness and disease management programming in accordance with the present invention, including three survey data inputs 101, 102 and 103 (Survey 1, Survey 2 and Survey 3), an administrative data input 104, a scoring engine 110 (including a processor 111 and data storage 112), and two data outputs (scorecard 120 and presentation 121).

System 100 may be implemented as an organizational risk assessment tool (“ORA”) as described in detail below. The system and method of the present invention also may be implemented using alternative designs and methodologies that enable standardized assessment of organizational health and wellness related risks and/or readiness for disease management programming.

In one implementation, the organizational risk and/or readiness assessment process may be initiated by entering a type of organization to be assessed, for example, via administrative data input 104. For example, the organization may be an employer, a private for-profit entity, a private not-for-profit entity, a public entity, etc. For the selected organization, one or more worksites may be identified, such as one or more physically contiguous workspaces or plots associated with one facility having one or more buildings. In some instances, one building may be assayed per worksite and its findings generalized to guide interventions to alter the physical, nutritional, and informational environments across all of the site's buildings. Additional administrative data may also be input via administrative data input 104 as needed to implement the desired organizational assessment.

The surveys used to collect data provided to scoring engine 110 via surveys 101, 102, and 103. The type of organization to be assessed may impact the type of information sought in the surveys. The survey questions may be designed in any desired format to enable collection of any desired health, wellness or other data as may be helpful to ascertain risk and readiness information for the organization. Surveys may be conducted electronically, on-line, using paper materials, in person, via telephone or in any desired manner and format.

In one implementation of system 100, the surveys may be designed using an environmental approach to worksite wellness. The environmental approach is designed to promote employee wellness by altering worksite settings, leadership and health culture for all employees alike independent of health risk factors. In one implementation, seven environmental domains are assessed: physical, informational, nutritional, grounds, neighboring, policy, and educational. Additionally, two perception domains are assessed: leadership support and employee perceptions of health culture. In alternative embodiments of system 100, a subset of these domains and/or additional domains may be surveyed.

In the example provided in FIG. 1, three types of surveys are utilized to collect data for input to scoring engine 110. The surveys are used to gather data concerning the seven environmental and two perception domains described above.

The first survey 101 may be an environmental and physical worksite and building survey (“environmental survey”) in which a worksite's grounds, neighborhood, policy, and education environments and one or more of the worksite's buildings' physical, nutritional, and informational environments are assessed. In one implementation, this survey may be designed using a refined and revised set of items based on work from the Checklist of Health Promotion Environments at Worksites (CHEW) (Oldenberg, 2002, et al.: Checklist of Health Promotion Environments at Worksites, AJPH (2002) 288-299).

The environmental survey may be conducted in multiple sessions and may be conducted as on-site personnel interviews during which worksite specifications and policy, education, and neighborhood environments are assayed. Additionally, the environmental survey may include a survey of the physical grounds of the organization, during which the physical, nutritional, and informational environments are assayed. An example of survey questions for an environmental survey is provided in Appendix I.

The second survey 102 may be a leadership survey that assays leadership's perceptions of wellness priorities, strategy, management alignment, agenda, and culture. In one implementation, this survey may be based upon field experience, for example, from HSS's worksite wellness National Institutes of Health grant in Vermont (NIH Grant Number: 5R01DP000108-04—Project Title: Worksites overweight/obesity control/prevention trial—PI Information: ROSS, ROBERT H. rhross@mcph.org). This survey may be conducted in sessions with a worksite's leadership, typically five to six top managers representing the worksite's major functional divisions. Managers may be interviewed separately. An example of survey questions for a leadership survey is provided in Appendix II.

The third survey 103 may be a health culture survey that assays employees' perceptions of job content, work climate, lifestyle support, and leadership, teamwork and diversity norms. This survey may be implemented as a sub-set of questions found in the General Social Survey's National Institute of Occupational Safety and Health, quality of work life supplement (NIOSH (2002): Quality of Work Life Survey: www.cdc.gov/niosh/topics/stress/qwlquest.html. The health culture survey may be conducted using an on-line, paper, in-person, telephone, or electronic format with a stratified random sample of employees (e.g., one in four employees) at all levels of the organization. An example of survey questions for a health culture survey is provided in Appendix III.

The leadership and health culture surveys 102 and 103 may be utilized to capture employer and employee perceptions, respectively. Employer perceptions may indicate what efforts the organization's leadership is willing to make in order to alter the worksite's environments to become more health promoting. Employee perceptions may indicate what steps employees are willing to take to avail themselves of the opportunities presented by these alterations to improve diet, increase physical activity, reduce stress, quit smoking, drink responsibly, and feel better about themselves. Additionally, these perceptions may change when system 100 is implemented for intervention.

Once survey data is collected, for example, using one or more of the three surveys discussed above, the survey data is provided to scoring engine 110. When the survey data is collected electronically, the raw data may be provided electronically to scoring engine 110 for processing. When survey data is collected in a non-electronic format, such as using paper survey forms, the data may be input into scoring engine 110 manually or translated into electronic format. For example, survey data collected on paper questionnaires may be scanned using optical character recognition (OCR) software to convert the data into an electronic format for analysis by scoring engine 110. For example, an OCR system may serve as a double data entry system. First, OCR reads each survey. Second, where OCR does not recognize text or answer choices, it alerts a verification staff person, who confirms or enters the correct information.

Once databases for each survey are completed, data checks may be implemented to validate the data for any out of range values. The data for each survey 101, 102, and 103 is stored in tabular format by scoring engine 110.

Scoring engine 110 stores one or more algorithms for processing the stored survey data and generates organizational risk and/or readiness scores. Such algorithms may be input and managed, for example, via administrative data input 104. In one implementation, one algorithm is provided for each type of survey data received from survey data inputs 101, 102 and 103.

The algorithms described below may be implemented using the Statistical Analysis System (SAS) of software products developed by the SAS Institute of Cary, N.C.

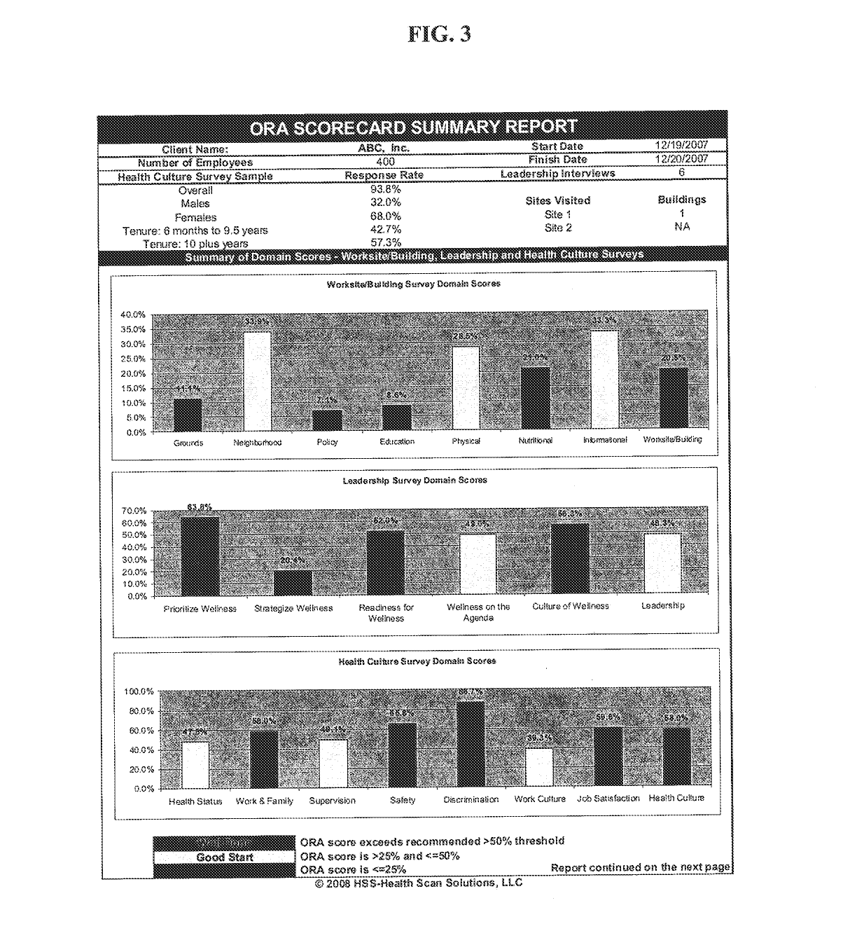

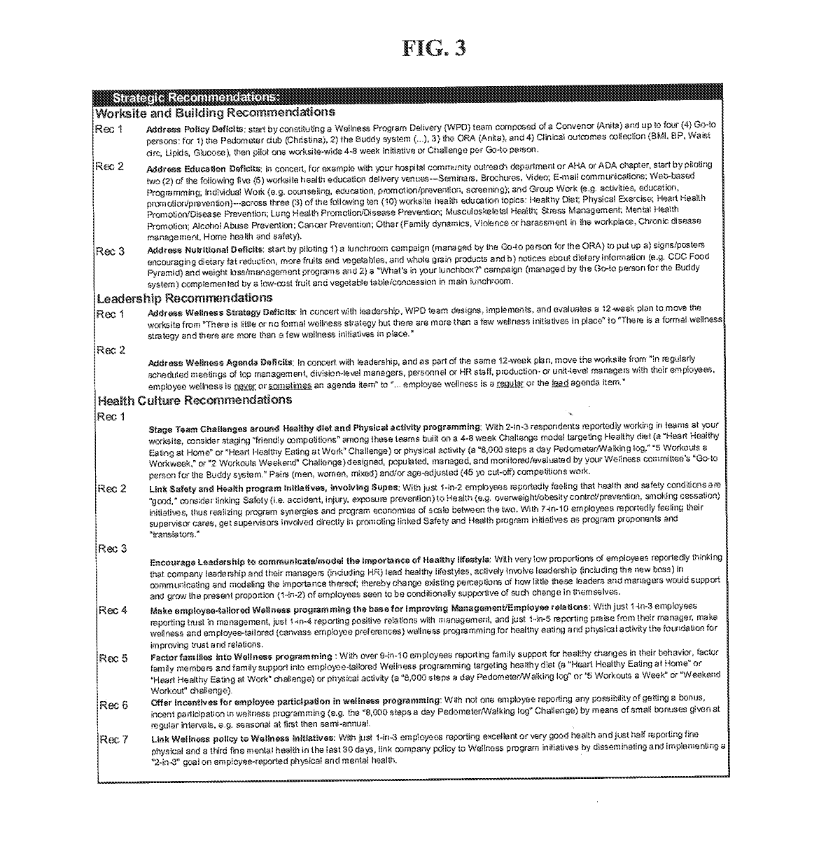

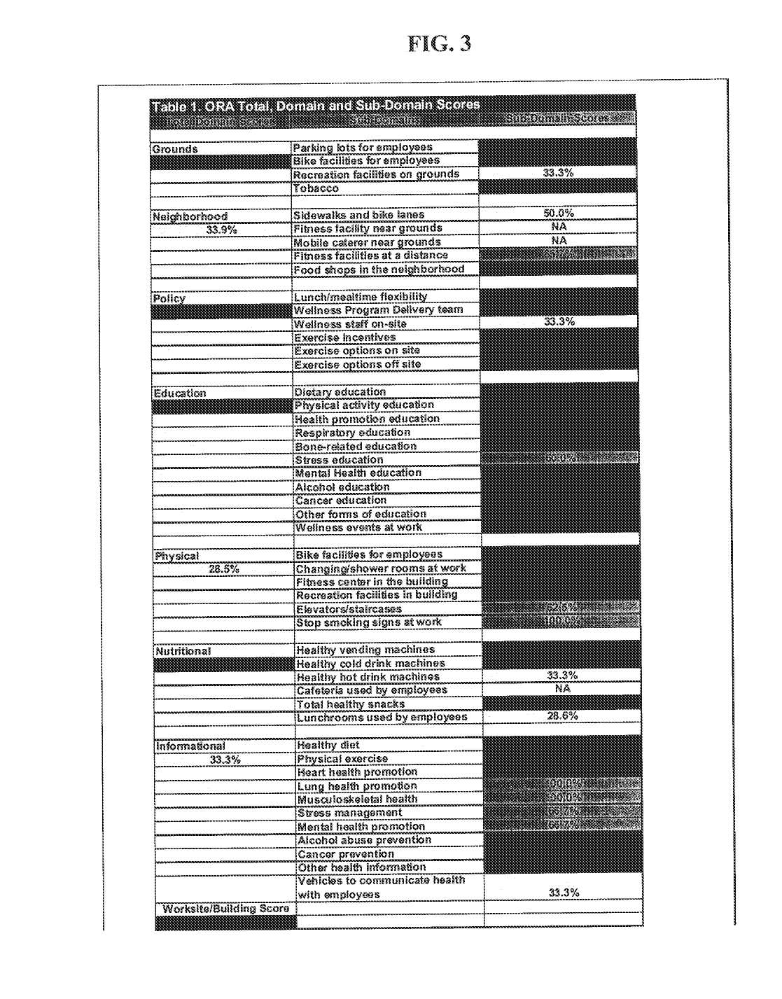

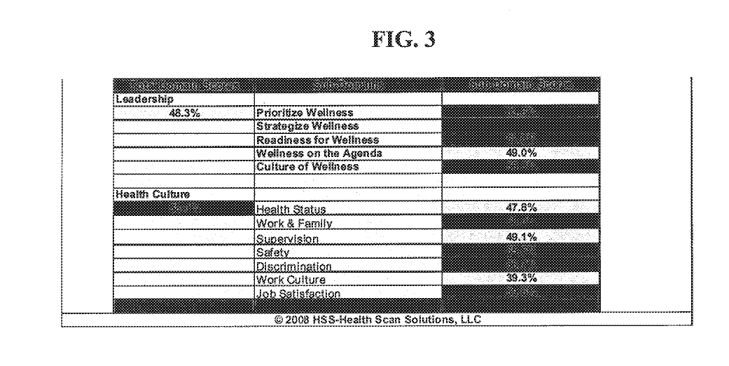

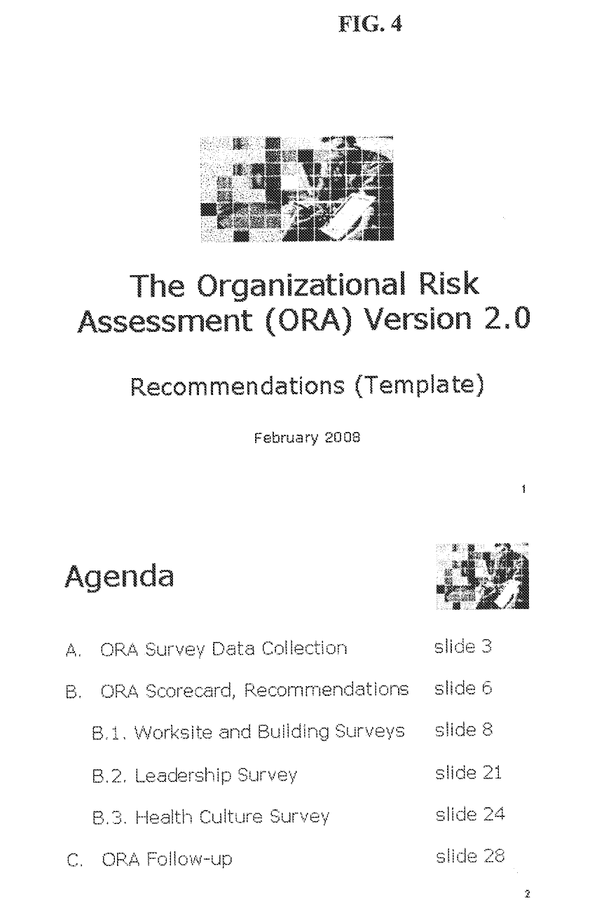

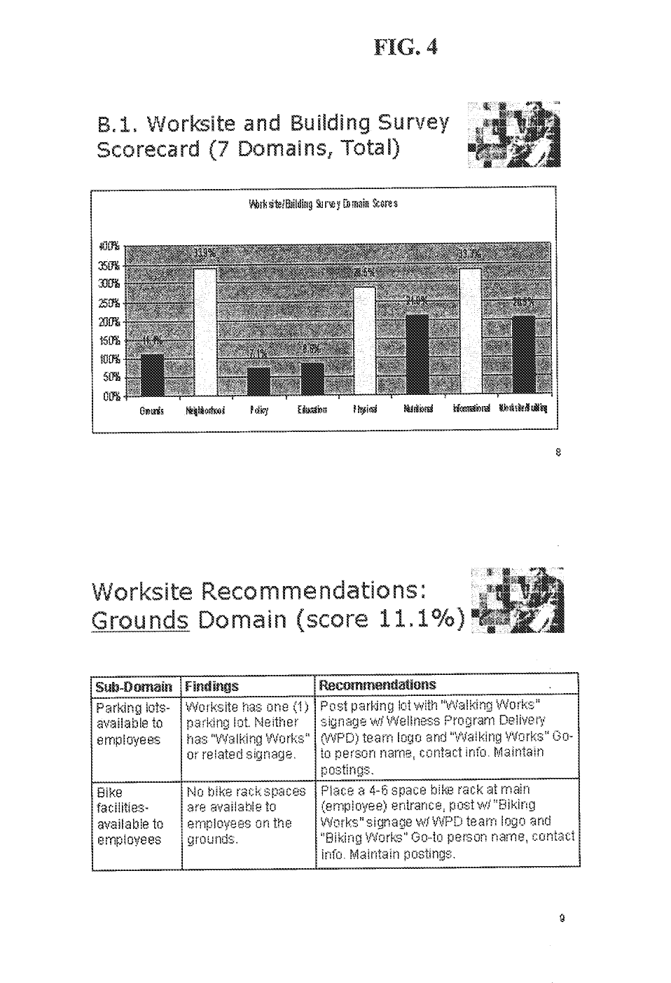

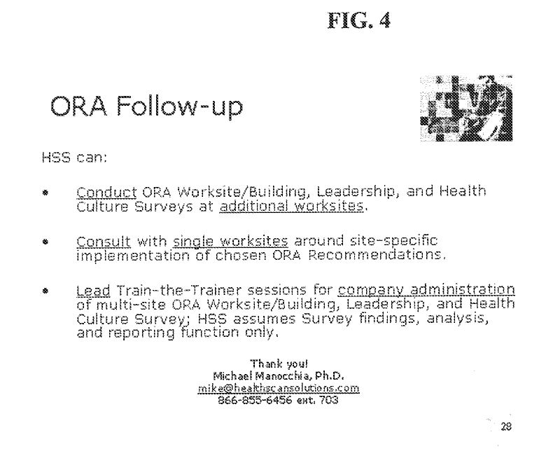

A first scoring algorithm for environmental survey data received from survey 101 may be implemented as follows:
Item analysis—each item is scored into a binary function of present or not present (1=presence of a positive environment or physical space factor, 0=lack of a positive environment or physical space factor). The survey data is binary data (either a 0 or 1 value for each survey response).
Pre-sub domains—in some cases items are grouped before they become sub-domains to arrive at a score representing one concept of a sub-domain
   In this case, the algorithm equally weights the items and takes an average score (from the item binary scores)
   If an item is non-applicable (“NA”), the pre-sub domain score is created from the remaining items—by again taking the average of the remaining items
Sub-domains—items or pre-sub domain scores are summed and averaged to arrive at a sub-domain score
Domains—sub-domains are averaged to arrive at each domain score
Total Survey 101 Score—domains are averaged to arrive at an overall score for data from environmental survey 101
Weighing of data—It may be desirable to implement a weighting logic around items, sub-domains and domains, and the overall score, to reflect the importance of the domains in question. Alternatively, equal weights may be assigned to the presence or absence of concepts. Equal weighing is utilized in the score card and presentation examples shown in FIGS. 3 and 4.

A second scoring algorithm for leadership survey data received from leadership survey 102 may be implemented as follows:
Item analysis—each item is coded or reverse coded (if the item has a negative connotation) into a scale where 1 is worst and 1+N is best depending on the survey 102 item in question. Thus, the survey data is scalar (answers ranked on a scale of 1 to N). The qualitative answers to survey 102 are not used in the algorithm scoring.
Domain scores—given the rating nature of the questions and the best to worst scoring associated with this rating system—a mathematical formula is set to look across the array of items within each leadership survey domain and arrive at a score of 0 to 100 using what is called summated rating techniques.
An example with a leadership domain called strategy with 3 items and a scale that has only two levels (1=little to no strategy; and 2=usually to always having a strategy) is as follows:

```
ARRAY SM(3) SE1-SE3;
DO I = 1 T03;
  IF SM(I) < 1 OR SM(I) > 2 THEN SM(I) = .;
END;
STRATNUM = N(OF SE1-SE3);
STRATMEAN = MEAN(OF SE1-SE3);
DO I = 1 TO 3;
  IF SM(I) =. THEN SM(I) = STRATMEAN;
END;
IF STRATNUM GE 2 THEN RAWSE = SUM(OF SE1-SE3);
STRATD = ((RAWSE- 3)/(6-3)) * 100;
Label STRATD=‘Strategy Domain Score’;
```

If missing rating questions are found, the half-present rule is applied to attribute answers to missing rating questions (STRATMEAN above). Thus, when scoring a leadership domain, there needs to be at least half of those items present to calculate the domain score.
Normalization of scores—Survey domain scores may be normalized to enable comparison of a worksite's score to database averages by normalizing the worksites score using benchmark data.
Weighing of data—It may be desirable to implement a weighting logic around items, sub-domains and domains, and the overall score, to reflect the importance of the domains in question. Alternatively, equal weights may be assigned to the presence or absence of concepts. Equal weighing is utilized in the score card and presentation examples shown in FIGS. 3 and 4.

A third scoring algorithm for health culture survey data received from health culture survey 103 may be implemented as follows:
Item analysis—each item is coded or reverse coded (if the item has a negative connotation) into a scale where 1 is worst and 1+N is best depending on the survey 103 item in question. Thus, the survey data is scalar (answers ranked on a scale of 1 to N). Any qualitative answers to survey 103 are not used in the algorithm scoring.
Domain scores—given the rating nature of the questions and the best to worst scoring associated with this rating system—a mathematical formula is set to look across the array of items within each survey 103 domain and arrive at a score of 0 to 100 using what is called summated rating techniques.
An example with a survey domain called discrimination which has 3 items and a scale that has only two levels (1=having discrimination based on age, gender or ethnicity at work and 2=no discrimination) is as follows:

```
ARRAY DM(3) DE1-DE3;
DO I = 1 TO 3;
  IF DM(I) < 1 OR DM(I) > 2 THEN DM(I) = .;
END;
DISCRIMNUM = N(OF DE1-DE3);
DISCRIMMEAN = MEAN(OF DE1-DE3);
DO I= 1 TO 3;
  IF DM(I) = . THEN DM(I) = DISCRIMMEAN;
END;
IF DISCRIMNUM GE 2 THEN RAWDE = SUM(OF DE1-DE3);
DISCRIMD = ((RAWDE - 3)/(6-3)) * 100;
LABEL DISCRIMD=‘Discrimination Domain Score’;
```

If missing rating questions are found, the half-present rule is applied to attribute answers to missing rating questions (DISCRIMMEAN above). This means that when scoring a Survey 3 domain, there needs to be at least half of those items present to calculate the domain score.
Normalization of scores—Survey domain scores may be normalized to enable comparison of a worksite's score to database averages by normalizing the worksites score using benchmark data.
Weighing of data—It may be desirable to implement a weighting logic around items, sub-domains and domains, and the overall score, to reflect the importance of the domains in question. Alternatively, equal weights may be assigned to the presence or absence of concepts. Equal weighing is utilized in the score card and presentation examples shown in FIGS. 3 and 4.

After each scoring algorithm described above has been implemented, an overall scoring algorithm creates categories across all sub-domains, domains and overall scores. For example, survey scores may be grouped or banded as follows: Needs work (scores of 0-25%), Good start (>25%-<=50%) and Well done (>50%). This banding is conservative to account for observed bias in survey responses. For example, organization leaders tend to be somewhat more candid about areas where they are not responsible (a production manager talking about health promotion in the workplace), and employees tend to be somewhat less candid in reporting problems at work depending on who originated the survey (e.g., their employer or someone like a vendor who is directly tied to their employer).

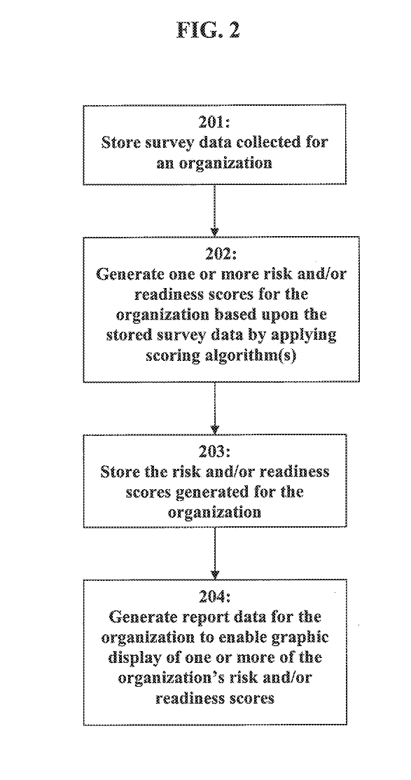

With reference to FIG. 2, a method for assessing organizational risk and/or readiness for wellness and disease management programming performed by the scoring engine 110 of system 100 in FIG. 1 includes:

201: storing survey data collected for an organization to be assessed, wherein the survey data for the organization includes environmental survey, data, leadership survey data and health culture survey data;

202: generating one or more risk and/or readiness scores for the organization based upon the stored survey data by (a) applying a first scoring algorithm to the environmental survey data to generate at least one environmental risk and/or readiness score, (b) applying a scoring algorithm to the leadership survey data to generate at least one leadership risk and/or readiness score, and (c) applying a third algorithm to the health culture survey data to generate at least one health culture risk and/or readiness score;

203: storing the risk and/or readiness scores generated for the organization; and

204: generating report data for the organization to enable graphic display of one or more of the organization's risk and/or readiness scores.

As discussed above with reference to the operation of scoring engine 110, the stored survey data may include binary survey data and scalar survey data.

With reference to FIG. 3, the scores generated by scoring engine 110 using the above-described algorithms and data from surveys 101, 102 and 103 are used to generate a report, for example in the form of a scorecard. Additionally, the scores may also be transcribed into a presentation of recommendations as illustrated in FIG. 4.

The SAS algorithms described above export a line of scores that contain each sub-domain and domain score. Those scores may be exported to a data worksheet in Microsoft® Excel®. Descriptive values from each survey, like employee size, demographics and survey dates may also be exported and used to populate the scorecard.

The Excel reporting engine uses cell-based scoring rules that are built to reference the data worksheet. When the report and data worksheet are connected, this automatically creates the scorecard which creates color-coded excel cells (with data points included) that indicate the priority of the sub-domain and domain for each client. The data work sheet also includes exported survey values, like sample size, demographics and survey dates, all of which get populated on the scorecard and reside in the scoring engine 110 data repository. The Excel sheet also automatically produces graphs of each Survey across domains and an overall score for Survey 1, 2 and 3 respectively.

Once the Excel scorecard is created, this report may be used to develop detailed and tailored recommendations for each worksite on the second page of the scorecard either manually or automatically using recommendation generating software coding. An exemplary scorecard generated using this approach is shown in FIG. 3.

Once the Excel scorecard is complete and formatted, the Excel graphs and sub-domain and domain scores are then populated on the Recommendation Presentation such as shown in FIG. 4.

System 100 may be implemented as an instrument that collects and reports cross-sectional or longitudinal data on the configuration of workplace and building environments and leadership and health culture perception fields as described above. Additionally, system 100 may be implemented to serve surveillance and programming functions, such as:
to collect and report longitudinal (pre/post) data on the configuration of these seven workplace/building environments and leadership and culture perception fields; and
to guide implementation of well-defined programming capable of reducing employee health risk factors including unhealthy diet, physical inactivity, unmitigated stress, tobacco addiction, alcohol abuse, and depression.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A method to implement a wellness and disease management program, the method comprising:
storing survey data collected from employees within an organization to be assessed, wherein the survey data includes environmental survey data, leadership survey data and health culture survey data collected from the employees belonging to the organization;
a scoring engine for generating one or more readiness scores for the organization based upon the stored survey data independent of individual health factors of the employees, wherein the scoring engine (a) applies a first scoring algorithm to the environmental survey data of physical grounds of a worksite, building, neighborhood, or any combination thereof, to generate at least one environmental readiness score associated with the employees within the organization providing the survey data, (b) applies a scoring algorithm to the leadership survey data to generate at least one leadership readiness score associated with the employees within the organization providing the survey data, and (c) applies a third algorithm to the health culture survey data to generate at least one health culture readiness score associated with the employees within the organization providing the survey data;
generating a graphic display of one or more of the organization's readiness scores; and
implementing the wellness and disease management program based on the graphic display.

2. The method of claim 1, wherein the stored survey data includes binary survey data and scalar survey data stored in the data storage.

3. The method of claim 1, wherein the scoring generator generates a plurality of environmental readiness scores and an overall organization-wide environmental score.

4. The method of claim 3, wherein the environmental readiness scores are generated using binary environmental survey data stored in a data storage.

5. The method of claim 1, wherein the scoring generator generates a plurality of leadership readiness scores and an overall organization-wide leadership score.

6. The method of claim 5, wherein the leadership readiness scores are generated using scalar leadership survey data stored in the data storage.

7. The method of claim 1, wherein the scoring generator generates a plurality of health culture readiness scores and an overall, organization-wide, health culture score.

8. The method of claim 7, wherein the health culture readiness scores are generated using scalar health culture survey data stored in a data storage.

9. The method of claim 1, wherein the report data enables color-coded display of the readiness scores generated by the scoring generator.

10. A method to implement an organization-wide wellness and disease management program, the method comprising:
storing survey data collected for an organization to be assessed in a data storage by a computer processor, wherein the survey data for the organization includes environmental survey data, leadership survey data and health culture survey data;
generating one or more readiness scores for the organization based upon the stored survey data to provide recommendations altering worksite settings, leadership and health culture for all employees independent of individual health factors of the employees by (a) applying a first scoring algorithm to the environmental survey data of physical grounds of a worksite, building, neighborhood, or any combination thereof, to generate at least one environmental readiness score, (b) applying a scoring algorithm to the leadership survey data to generate at least one leadership readiness score, and (c) applying a third algorithm to the health culture survey data to generate at least one health culture readiness score, the generating being performed by the computer processor;
storing the scores generated for the organization in the data storage;
generating a graphic display of one or more of the organization's readiness scores; and
implementing the wellness and disease management program using the graphic display.

11. The method of claim 10, wherein the stored survey data includes binary survey data and scalar survey data stored in the data storage.

12. The method of claim 10, wherein a plurality of environmental readiness scores and an overall, organization-wide environmental score are generated by the computer processor.

13. The method of claim 12, wherein the environmental readiness scores are generated by the computer processor using binary environmental survey data stored in the data storage.

14. The method of claim 10, wherein a plurality of leadership readiness scores and an overall, organization-wide leadership score are generated by the computer processor.

15. The method of claim 14, wherein the leadership readiness scores are generated by the computer processor using scalar leadership survey data stored in the data storage.

16. The method of claim 10, wherein a plurality of health culture readiness scores and an overall, organization-wide health culture score are generated by the computer processor.

17. The method of claim 16, wherein the health culture readiness scores are generated by the computer processor using scalar health culture survey data stored in the data storage.

18. The method of claim 10, wherein the report data enables color-coded display of the readiness scores.

19. A system to implement a wellness and disease management program, the system comprising:
employee health and wellness related survey data collected from employees of an organization to be assessed;
a scoring engine for generating one or more organization-wide, health-related readiness scores for the employees of the organization and used to provide recommendations altering worksite settings, leadership and health culture for all employees independent of individual health factors of the employees by applying at least one scoring algorithm to the stored employee health and wellness related survey data, wherein the scoring engine stores the employee health-related readiness scores;
a graphic display of organization-wide health-related readiness scores to implement the wellness and disease management program.

20. The system of claim 19, wherein the employee health and wellness related survey data for the organization includes environmental survey data of physical grounds of a worksite, building, neighborhood, or any combination thereof.
